(19) United States
(12) Patent Application Publication
(10) Pub. No.: US 2005/0042444 A1
(43) Pub. Date: Feb. 24, 2005

(54) Self-adhesive protective sheet for temporary protection of vehicle finishes

(75) Inventors: Nicolai Bohm, Hamburg (DE); Jobst-Waldemar Klemp, Schenefeld (DE); Bernd Luhmann, Norderstedt (DE); Michael Portmann, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 10/816,368

(22) Filed: Apr. 1, 2004

(30) Foreign Application Priority Data
Apr. 17, 2003 (DE) 103 18 151.2

(51) Int. Cl. B32B 7/12

(52) U.S. Cl. 428/343

(57) ABSTRACT

Self-adhesive protective sheet having improved paint compatibility, comprising a thermoplastic backing film and a self-adhesive layer of a butyl rubber, the isoprene content of the butyl rubber being up to 1.8% wt.

The invention relates to a self-adhesive sheet for temporary protection of fresh paint surfaces of vehicles such as cars and freshly painted vehicle parts against soiling and damage in the course of assembly, transit and storage and also to its use on vehicles, especially on cars.

For many years it has been common to protect the finish of new vehicles in transit from the manufacturer to the end customer against harmful environmental effects such as stone chipping, fly rust or bird droppings. Temporary self-adhesive protective sheets have become particularly widespread in this context, since they are inexpensive to apply and have a satisfactory protective effect. Hoods, which enclose the entire vehicle and in some cases can be applied by a shrink-on method, have a range of disadvantages, owing to which they have as yet found no great acceptance in the market. One particular advantage of the protective sheets is that they can if desired be applied directly after finishing, even before assembly, and hence additionally provide assembly protection.

A key requirement of a temporary surface protection sheet is its weathering stability and light stability over a period of several months. Accordingly, such a sheet must be removable even after a six-month period spent in extreme climatic circumstances such as, for example, the Florida climate without embrittlement and without leaving residues of adhesive as a result of light-induced decomposition. It is likewise necessary to ensure that in cases of elevated surface temperature of the vehicle, as may occur in southern regions or in the case of direct insolation, removal of the adhesive is not accompanied by failure, either cohesively or adhesively to the backing film, and/or is not accompanied by residues of adhesive left behind. Moreover, users expect a balanced set of adhesion characteristics: that is, although the sheet should have a good initial bond strength, it should not be too difficult to remove after use—in other words, it should not exhibit excessive peel increase. An overriding requirement is that of paint compatibility, which means that, following removal of the protective sheet, the paint surface should not exhibit any impairments whatsoever in the form of irreversible deformations. Deformations are imprints in the paint which are manifested in the form of sheet edge contours, bonded-in air bubbles and creases, or in the form of change in surface structure below the entirety of the overstuck area. This requirement is particularly demanding if the sheet is adhered to the bodywork a short time, in some cases just 30 minutes, after the paint has been baked, still prior to the assembly of the vehicle.

Reversibly adhesive surface protection sheets available to date show considerable defects in respect of one or more of the abovementioned features.

In accordance with the prior art, the sheet materials generally used for temporary surface protection are polyolefins or mixtures thereof, normally in the form of blends with light stabilizers and titanium dioxide.

On the market at the present time are, essentially, three adhesive systems, based on polyacrylates, polyethylene vinyl acetate, and polyisobutylene.

The first system, although it is known to have good light stability and it can also be relatively well balanced in its adhesion properties in terms of initial adhesion and final adhesion, given an appropriate selection of the comonomers, has a paint compatibility which is inadequate. In the area, in particular, irreversible surface changes are evident on the majority of vehicle finishes.

A paint protection sheet based on polyethylene-vinyl acetate (EVA) is described in DE 195 32 220 A1. This system attains good bond values after just a short time and ensures a high degree of bonding security against unwanted spontaneous detachment during transit. Disadvantages perceived by the user include the strong peel increase, which can be lessened with a sophisticated mixture of different EVA copolymers as described in DE 100 50 499 A1. With this adhesive base as well, the paint compatibility is not always optimum. With EVA, particularly in creases and bubbles, strong irreversible deformations are observed on numerous OEM finishes. The high polarity of both of the systems specified is probably responsible for the strong interactions with the likewise polar paints.

The best-known example of an apolar adhesive base is natural rubber. Compositions formulated appropriately with plasticizers, tackifier resins and fillers do in fact display outstanding paint compatibility, but—less surprisingly—do not exhibit adequate light stability, owing to the numerous double bonds in the polymer main chain; the consequence of this is that after just a short period in use the sheet can be removed only with residues of adhesive which are greasy or, in the further course of time, may even have hardened to a paintlike state. Speciality adhesive tapes for the design painting sector, for two-colour finishing, generally make recourse to adhesive tapes based on natural rubber. In some cases, such tapes are adhered to completely fresh paint areas and, following the second application of paint, are heated for up to an hour at 150° C. in order to bake the paint. Thereafter the first paint layer has no visible changes in the form of imprints.

One representative of an apolar synthetic rubber is polyisobutylene. A protective sheet with this adhesive system is described in, for example, EP 0 519 278 A1 and features much better weathering stability than natural rubber, owing to the absence of double bonds. The paint compatibility, though frequently satisfactory, is less good on many paints than that of natural rubber compositions.

It is an object of the present invention to provide a self-adhesive protective sheet which no longer has the disadvantages of the prior art, or at least not to the same extent. The aim is in particular to solve the problem of the unsatisfactory paint compatibility of the weathering-stable adhesives known from the prior art without recourse to natural rubber, since the latter is not stable under weathering.

This object is achieved by means of a self-adhesive protective sheet as specified in the main claim. The dependent claims provide advantageous developments of the self-adhesive protective sheet and also particular possibilities for application.

The invention accordingly provides a self-adhesive protective sheet for the temporary protection of fresh paint surfaces of vehicles such as cars and freshly painted vehicle parts, having a backing comprising a thermoplastic film, preferably of polyolefins, which has been coated with a self-adhesive composition comprising butyl rubber, the isoprene fraction in the butyl rubber being up to 1.8 mole percent. An inventive sheet of this kind has a better paint compatibility than those containing polyisobutylene adhesives, while being sufficiently stable to light.

The adhesive is composed of butyl rubber, with the isoprene content of the butyl rubber being up to 1.8 mole percent, preferably up to 1.2 mole percent. It is applied at coatweights of between 3 and 35 g/m², preferably between 8 and 20 g/m². It can be applied from solution, for example in hexane or mineral spirit, or else from the melt, either by coextrusion together with the backing film or by calendering.

Butyl rubbers are copolymers of isobutene and isoprene which are prepared by cationic polymerization in solution. The isoprene fraction varies typically between 0.5 and 5 mole percent. The isoprene is normally incorporated in 1,4-addition, so that, in contrast to the polyisobutylene homopolymer, this copolymer has double bonds in the main chain. Accordingly it constitutes a link between a straight poly-cis-isoprene or natural rubber and a polyisobutylene homopolymer. This may be supposed to be the reason for the better paint compatibility observed for butyl rubber in comparison with polyisobutylene. The following speciality grades are also in accordance with the concept of the invention: a further group of butyl rubbers is that of the starbranched grades, in which more intensive branching is achieved by means of comonomers such as divinylbenzene. More recently, butyl rubbers having pendant double bonds have also become known (1,2- and/or 3,4-addition of the isoprene). Manufacturers of such products include in particular the companies Bayer (Bayer Butyl) and Exxon (Exxon Butyl).

Surprisingly, and unexpectedly even for the person skilled in the art, a protective sheet having the self-adhesive composition of the invention exhibits a sufficient weathering stability. Although the paint compatibility continues to rise with increasing isoprene fraction, above 1.8 mole percent the weathering stability begins to decrease markedly, so that the sheet no longer in every case withstands conditions typical of those in application, generally at least 6 months of Florida climate. The self-adhesive composition then begins gradually to decompose, a process which is manifested in more or less pronounced residues of adhesive, particularly in cases of elevated temperature and slow demasking speeds.

The self-adhesive composition of the invention affords an additional advantage over those comprising polyisobutylene, which is the most paint-compatible type of the systems represented in the market. Whereas polyisobutylenes are of strictly linear construction, the butyl rubbers have a branching site at approximately every tenth isoprene unit (see White et al., “Macromolecules”, 28 (1995) 3 290 to 3 300). In order to achieve sufficient cohesion for an adhesive application, especially at elevated temperatures, the molar mass advantageously at least of some of the polyisobutylenes used is relatively high, generally at least 200 000 g/mol (number average Mₙ).

For a given molar mass, on the other hand, the branched structure of the butyl rubbers produces a greater cohesion and a lower solution viscosity in a given solvent, thereby making processing more economic and more environmentally compatible: with a higher solids content of the composition, the coated web can be transported more rapidly through the drying tunnel, in order to evaporate the solvent, and at the same time the amount of solvent released, which has to be extracted from the outgoing air, in a costly and inconvenient procedure, is less. For the solvent-free process as well advantages are in evidence for butyl rubber. For the coating of polyisobutylene of sufficient cohesion from the melt in the form of a coextrusion simultaneously with the backing film, it proves to be virtually impossible to control the much greater melt viscosity of the polyisobutylene as compared with the film in such a way that a homogeneous sheet having a uniform thickness profile over the entire web width is obtained. This is much easier to achieve in the case of butyl rubber compositions having a cohesion in tune with the application, owing to the lower melt viscosity.

It is true that the butyl rubbers, similarly to polyisobutylenes of medium molecular weight, are inherently tacky. In order to optimize the properties, especially the adhesion characteristics, the adhesive of the protective sheet of the invention can nevertheless advantageously be blended with one or more additives. Possible such additives include tackifiers (tackifier resins which optimize pressure-sensitive adhesion properties), plasticizers, organic or inorganic fillers, pigments, light stabilizers, including those in the form of UV-absorbing, sterically hindered amines (HALS), ageing inhibitors in the form, for example, of lactones, primary and secondary antioxidants, or further elastomers. As an option, crosslinking agents and crosslinking promoters can be added to the self-adhesive composition. An exhaustive selection of crosslinking agents and crosslinking promoters is described in Ullmann's Encyclopedia of Industrial Chemistry (6th edition, 2003), section “Rubber, 4. Chemicals and additives” and “Manual for Rubber Industry”, Bayer AG (1995).

Examples of possible elastomers for modifying the self-adhesive composition include polyisobutylenes, polyolefin copolymers such as EPM or EPDM, polybutenes, hydrogenated block copolymers of styrene and dienes, and acrylate copolymers. These elastomers are used in proportions in the range from 0 to 20 parts by weight, preferably less than 10 parts by weight per 100 parts by weight of butyl rubber.

Examples of suitable tackifiers include synthetic hydrocarbon resins (of C5 or C9 monomers, for example), natural resins, polyterpene resins based on α- or β-pinene or δ-limonene, rosin and rosin derivatives, and others, as listed in Ullmann's Encyclopedia of Industrial Chemistry (6th edition, 2003), section “Resins, Synthetic” and “Resins, Natural”. Primarily use is made of fully or partly hydrogenated resins, which are more stable to ageing. In the adhesive of the protective sheet of the invention it is preferred to use from 0 to 50 parts by weight, in particular from 0 to 20 parts by weight, of a tackifier per 100 parts by weight of base polymer.

Examples of suitable plasticizers for the self-adhesive composition include aliphatic, cyclooaliphatic and aromatic mineral oils, diesters or polyesters of phthalic acid, trimellitic acid or adipic acid, liquid rubbers (nitrile rubbers or polyisoprene rubbers, for example), liquid polymers (of isobutene or ethylene/propylene), acrylates, polyvinyl ethers, liquid resins and soft resins based on the raw materials of tackifier resins, lanolin and other waxes, or liquid silicones. Ageing-stable plasticizers without an olefinic double bond are particularly suitable. It is preferred to use from 0 to 40 parts by weight, in particular from 0 to 10 parts by weight, of a plasticizer per 100 parts by weight of base polymer.

Backing materials used for the protective sheet of the invention are thermoplastic films, preferably polyolefin films. They may be composed, for example, of polyethylene, polypropylene and also mixtures or copolymers thereof (random copolymer or polypropylene block copolymer, for example). In order to establish particular mechanical properties such as toughness, flexibility, gloss, bonding to the adhesive, extrusion characteristics or surface structure, the films may also include different amounts of other polyolefin copolymers, such as copolymers of ethylene and α-olefins such as 1-butene, 1-hexene and 1-octene (called LLDPE, VLDPE or ULDPE or metallocene-PE, depending on proportion and manufacturing process), but also ethylene-styrene copolymers, ethylene with polar comonomers such as acrylic acid, and copolymers of propylene with α-olefins, such as ethylene, 1-butene, 1-hexene and 1 -octene.

Suitable thicknesses for the backing films are from 20 to 80 μm (including the adhesion promoter layer where appropriate). The flexibility of the backing film has a part to play in the content of deformability during the application of the protective sheet: the force at 10% elongation should not exceed 25 N/15 mm, preferably 16 N/15 mm, both in the longitudinal direction and in the transverse direction. Owing to their thermal contraction resistance and effective deformability, propylene copolymers are especially suitable. Suitable films are described in DE 199 23 780 A1 and DE 196 35 704 A1.

In order to endow the backing film with the requisite weathering stability it is preferable to add light stabilizers. Their function consists primarily in the prevention of embrittlement of the backing film.

Light stabilizers of this kind are described in Gaechter and Muller, Taschenbuch der Kunststoff-Additive, Munich 1979, in Kirk-Othmer (3rd) 23, 615 to 627, in Encycl. Polym. Sci. Technol. 14, 125 to 148, and in Ullmann's Encyclopedia of Industrial Chemistry (6th edition, 2003), “Antioxidants” section. HALS light stabilizers are especially suitable for the protective sheet of the invention. The amount of light stabilizer ought to be at least 0.15% by weight, preferably at least 0.30% by weight, based on the backing film.

An additional improvement in the light stability of the backing film is also possible through addition of titanium dioxide. Advantageous in terms of the mechanical properties and the homogeneity of the whiteness is a titanium dioxide addition of from 5 to 15% by weight.

As a result of the interaction of light stabilizers and pigments, the UV transmittance of the protective sheet in the region from 290 to 360 nm is preferably below about 1%, more preferably below about 0.1%. For optical reasons the sheet may also be colour-pigmented.

Films of this kind can be manufactured on calenders, blowing units or, preferably, casting units (T-die technology), with the film not being monoaxially or biaxially oriented by stretching (drawing) with drawing rolls or drawing frames. During the blowing of such a film, the orientation should be minimized by way of take-off speed, blow-up ratio and temperature profile. For reasons of greater ease of processing, particularly in the case of the blown film process, it may be advantageous to add antiblocking agents, chalk or talc for example.

The film itself may be composed of a plurality of individual layers.

In order to improve the adhesion between film and self-adhesive composition it is advantageous, though not mandatory, to use an adhesion promoter layer. In such a case the backing film is composed of at least one base layer and one adhesion promoter layer. The latter is composed preferably of a relatively low-density polyolefin, a blend of two or more polyolefins and/or components of the base layer and/or components of the adhesive. The use of an adhesion promoter layer makes it possible to ensure that even at elevated product temperatures, such as are often reached under insolation conditions, the protective sheet can be removed from the surface to be protected without leaving residues. Alternatively a physical pretreatment of the film, such as corona discharge or flame pre-treatment, is very effective at improving the adhesion between film and adhesive.

Improving the unwind force of roll product requires the use of a release layer in the case of the protective sheet of the invention. This release layer may take the form of a coating on the reverse of the film. In this case it is preferred to use silicones or polyvinyl carbamates, especially polyvinyl stearyl carbamate (PVSC), applied at from 0.01 to 0.5 g/m². In the case of coextruded films the film layer containing release agent can be located on the base layer.

A protective sheet of the invention realized in this fashion is easy to apply to the paint areas of freshly painted bodywork or brand-new vehicles straight from the plant, and/or components for external mounting thereon, even when the areas to be overstuck are curved. The protective sheet unites the desired properties of effective initial adhesion, secure adhesion during transport, and untroubled removability, since the peel increase, even over the long term or under the effect of heat, is low. Damp (rain, fog, dew) and cold weathering conditions are also withstood by the sheet without unwanted instances of spontaneous detachment.

Particularly noteworthy is the outstanding paint compatibility, which exceeds that of the standard market products known from the state of the art. This applies even to very fresh finishes, having left the drying oven just 30 minutes before being overstuck. In spite of the double bonds incorporated in the butyl rubber, stability to weathering is found, surprisingly, to be maintained over a period of six months under Florida climate. Even after such exposure, the film can be removed without tearing due to embrittlement and without leaving residues of adhesive, even when demasking takes place under elevated temperatures, such as in the midday sun in summer, or with very slow removal speeds. Beneath the sheet, at folds, at the edges of the sheet or at bonded-in air bubbles, paint deformations are seen to a lesser extent than in the case of standard market products with polyacrylate, EVA or PIB adhesives. No optical impairments are visible at all in the area.

The protective sheet of the invention is therefore outstandingly suitable at fulfilling its purpose, namely to protect freshly painted cars or car parts against damage by mechanical and chemical influences in the course of assembly or in the course of transit from the production plant to the dealer.

The intention of the text below is to illustrate the invention with reference to examples, though without wishing to restrict it by so doing.

### EXAMPLES

All of the exemplary protective sheets were produced by coating the adhesives from solution onto a cast polyolefin film 50 μm thick and composed of 60 parts by weight of PP homopolymer, 30 parts by weight of LLDPE, 10 parts by weight of titanium dioxide and 0.3 part by weight of a HALS stabilizer (Tinuvin 770, Ciba). The film formulation ensured that the results were not falsified by premature embrittlement of the film. All of the specimens were coated in such a way as to result in an adhesive coatweight of 15 g/m²±2 g/m² after five minutes' drying at 100° C. The formulation of the different self-adhesive compositions is depicted in Table 1.

TABLE 1
Overview of the self-adhesive compositions used
in the inventive examples and counter-examples

| | Inventive examles | | | | | | Counter-examples | | | | | |
|---|---|---|---|---|---|---|---|---|---|---|---|---|
| Raw materials | 1 | 2 | 3 | 4 | 5 | 6 | 7 | 8 | 9 | 10 | 11 | 12 |
| Butyl 100 | 100 | | | 90 | 85 | 80 | | | | | | |
| Butyl rubber from Bayer, | | | | | | | | | | | | |
| isoprene content 0.9 mol % | | | | | | | | | | | | |
| Butyl 065 | | 100 | | | | | | | | | | |
| Butyl rubber from Exxon, | | | | | | | | | | | | |
| isoprene content 0.9 mol % | | | | | | | | | | | | |
| Butyl 265 | | | 100 | | | | | | | | | |
| Butyl rubber from Exxon, | | | | | | | | | | | | |
| isoprene content 1.5 mol % | | | | | | | | | | | | |
| Butyl 365 | | | | | | | 100 | | | | | |
| Butyl rubber from Exxon, | | | | | | | | | | | | |
| isoprene content 2.4 mol % | | | | | | | | | | | | |
| Hyvis 200 | | | | 10 | | | | | | | | |
| Polybutene from BP Chemical | | | | | | | | | | | | |
| Oppanol B 50 | | | | | | | | | | | 100 | 85 |
| PIB from BASF, | | | | | | | | | | | | |
| Mₙ = 120 000 g/mol | | | | | | | | | | | | |
| Oppanol B 150 | | | | | 15 | 10 | | | | | | 15 |
| PIB from BASF, | | | | | | | | | | | | |
| Mₙ = 425 000 g/mol | | | | | | | | | | | | |
| Levapren 500 | | | | | | | | | | 100 | | |
| EVA from Bayer with 50 | | | | | | | | | | | | |
| percent by weight | | | | | | | | | | | | |
| vinyl acetate fraction | | | | | | | | | | | | |
| Regalite R 101 | | | | | | 10 | | | | | | |
| Hydrocarbon resin from Hercules | | | | | | | | | | | | |
| Adhesive based on natural rubber^{a} | | | | | | | | 100 | | | | |
| Adhesive based on polyacrylate^{b} | | | | | | | | | 100 | | | |
| Solvent mineral spirit 60/95 | X | X | X | X | X | X | X | X | | | X | X |
| Solvent toluene | | | | | | | | | | X | | |
| Solvent mineral spirits 60/95: | | | | | | | | | X | | | |
| acetone (80:20) | | | | | | | | | | | | |

^{a}60% natural rubber, 10% chalk, 15% terpene-phenolic resin, 10% poly-β-pinene resin, 5% mineral oil (percent by weight in each case)
^{b}Copolymer of 50% 2-ethylhexyl acrylate, 49% butyl acrylate, 1% acrylic acid (percent by weight in each case)

### Test Criteria

The following were regarded essentially as decisive test criteria for the suitability of a protective sheet for fresh car finishes, and were employed accordingly:
1. UV stability
2. Paint compatibility
3. Exertion of force for demasking of the sheet after use

The sequence of the criteria also reflects their performance significance (decreasing with increasing number), which is also reflected in the level of the points awarded for the test results.

### Test Procedure

### UV Stability

The UV stability was tested in accordance with EN ISO 4892-2 over 600 h. The test substrates used were metal specimen panels which had been painted with a water-based basecoat (colour: dark blue) and with a 2K PU clearcoat (BASF) in accordance with the manufacturer's specifications. 30 minutes after oven drying, specimens 2 cm wide and 15 cm long were bonded to these panels, with a number of creases being bonded in deliberately. Weathering took place in a weathering instrument from the company Atlas (Xenotest Beta). After the end of exposure, the strips were pulled off rapidly at angles of 90° and 180° and the traces of adhesive due to the influence of UV, which were readily detectable on the dark paint, were assessed visually in accordance with the following scheme:
0=no adhesive residues visible
3=minimal adhesive residues visible
5=moderate adhesive residues visible
7=distinct to full-area adhesive residues visible

### Paint Compatibility

Visual assessment for paint deformations was carried out using the panels from the UV stability test. Following assessment for traces of adhesive caused by the influence of UV, the paint panels were cleaned to remove any remaining traces of adhesive, using mineral spirit 60/95. The criterion serving for paint compatibility was the extent of paint deformations along the edge of the test strips, in creases and beneath the formerly overstuck area. The overall performance assessment was summarized in accordance with the following evaluation scheme:
0=no deformations perceptible
1=minimal deformations perceptible
3=moderate deformations perceptible
5=distinct deformations perceptible

### Exertion of Force For Demasking of the Sheet After Use

This criterion was determined subjectively by the test person during removal of the test strips after a residence time of 600 h in the Xenotest instrument. Assessment was made as follows:
0=balanced exertion of force
1=exertion of force somewhat too little (−) or too great (+)
3=exertion of force markedly too little (−) or too great (+)

### Results

The test results are summarized in Table 2 below. A low points score denotes a good overall performance assessment, a higher points score a poorer overall performance assessment.

TABLE 2
Compilation of the test results
of the example specimens

| | Inventive examples | | | | | | Counter-examples | | | | | |
|---|---|---|---|---|---|---|---|---|---|---|---|---|
| Test criterion | 1 | 2 | 3 | 4 | 5 | 6 | 7 | 8 | 9 | 10 | 11 | 12 |
| UV stability | 0 | 0 | 0 | 0 | 0 | 0 | 3 | 7 | 0 | 0 | 0 | 0 |
| Paint compatibility | 1 | 1 | 1 | 1 | 1 | 1 | 1 | 0 | 5 | 5 | 3 | 3 |
| Exertion of force for demasking | 0 | 0 | 0 | 1 (+) | 0 | 1 (+) | 0 | 1 (+) | 3 (+) | 3 (+) | 3 (−) | 3 (−) |
| Total points score | 1 | 1 | 1 | 2 | 1 | 2 | 4 | 8 | 8 | 8 | 6 | 6 |

The results show that protective sheets with adhesives based on butyl rubber are the most highly suited in respect of UV stability, paint compatibility and demasking behaviour. Although the natural rubber composition displays the best paint compatibility, it leaves residues of adhesive over the full area after UV weathering. The specimens with butyl compositions exhibit only minimal paint deformation and are even more paint-compatible than the PIB-based adhesives. In UV stability, in contrast, the two types of adhesive come out equal, with the exception of the Exxon Butyl type 365, which displays first weaknesses in cohesion after the 600 h Xenotest. In the case of the compositions of the invention the demasking behaviour is predominantly balanced, whereas the standard commercial adhesive systems (EVA and polyacrylate) exhibit strong peel increase and, additionally, cause severe deformation of the paint. PIB tends to detach too easily, which in practice could lead to spontaneous detachment.

Protective sheets for car finishes with adhesives based on butyl rubber having an isoprene content of up to 1.8 mole percent are outstandingly suitable, accordingly, for meeting the requirements made of them, especially UV stability, paint compatibility and balanced demasking behaviour, more effectively than protective sheets which conform to the known state of the art.

1. Self-adhesive protective sheet for the temporary protection of freshly painted surfaces, having a backing comprising a thermoplastic film, with a self-adhesive layer of butyl rubber, the isoprene content of the butyl rubber being up to 1.8 mole percent.

2. Self-adhesive protective sheet according to claim 1, wherein the butyl rubber is a starbranched type and/or contains pendant double bonds.

3. Self-adhesive protective sheet according to claim 1, wherein the self-adhesive layer is blended with one or more additives selected from the group consisting of tackifiers, plasticizers, organic or inorganic fillers, pigments, light stabilizers, ageing inhibitors, primary and secondary antioxidants, crosslinking agents and crosslinking promoters.

4. Self-adhesive protective sheet according to claim 1, wherein the self-adhesive layer is blended with elastomers in the amount of from 0 to 20 parts by weight, per 100 parts by weight of butyl rubber.

5. Self-adhesive protective sheet according to claim 1, wherein the coatweight of the self-adhesive layer on the backing film is between 3 and 35 g/m².

6. Self-adhesive protective sheet according to claim 1, wherein the backing film is comprised of polyolefins selected from the group consisting polyethylene, polypropylene and mixtures or copolymers thereof.

7. Self-adhesive protective sheet according to claim 6, further comprising copolymers of ethylene and α-olefins, ethylene-styrene copolymers, copolymers of ethylene with polar comonomers, and copolymers of propylene with α-olefins.

8. Self-adhesive protective sheet according to claim 1, wherein the thickness of the backing layer is between 20 and 80 μm, optionally including an adhesion promoter layer between the backing layer and the adhesive layer.

9. Self-adhesive protective sheet according to claim 1, wherein said backing layer comprises at least one light stabilizer in an amount of at least 0.15% by weight and/or titanium dioxide, in an amount of from 5 to 15% by weight.

10. Self-adhesive protective sheet according to at claim 1, having a UV transmittance in the wavelength region from 290 to 360 nm of less than 1%.

11 A method for protecting freshly painted surfaces of cars or car parts during assembly protection or transit, which comprises covering said surfaces with the protective sheet of claim 1.

12. A method for protecting sensitive paint, metal, plastic or glass surfaces, which comprises covering said surfaces with the protective sheet of claim 1.

13. The self-adhesive protective sheet of claim 1, wherein said isoprene content of said butyl rubber is up to 1.2 mole percent.

14. The self-adhesive protective sheet of claim 3, wherein said light stabilizers are in the form of UV-absorbing sterically hindered amines (HALS).

15. The self-adhesive protective sheet of claim 3, wherein said ageing inhibitors are lactones.

16. The self-adhesive protective sheet of claim 4, wherein said elastomers are selected from the group consisting of polyisobutylenes, polyolefin copolymers, hydrogenated block copolymers of styrene and dienes or acrylate copolymers.

17. The self-adhesive protective sheet of claim 4, wherein said amount of elastomers is below 10 parts per 100 parts by weight of butyl rubber.

18. The self-adhesive protective sheet of claim 4, wherein said coatweight is between 8 and 20 g/m².
